(19) United States
(12) Patent Application Publication
(10) Pub. No.: US 2015/0161529 A1
(43) Pub. Date: Jun. 11, 2015

(54) Identifying Related Events for Event Ticket Network Systems

(71) Applicant: Eventbrite, Inc., San Francisco, CA (US)

(72) Inventors: Srinidhi Ramesh Kondaji, Mountain View, CA (US); Anand Sujith Henry, San Francisco, CA (US); Vipul Sharma, San Jose, CA (US)

(73) Assignee: Eventbrite, Inc., San Francisco, CA (US)

(21) Appl. No.: 14/101,191

(22) Filed: Dec. 9, 2013

(51) Int. Cl. G06Q 10/06

(52) U.S. Cl. CPC G06Q 10/063

(57) ABSTRACT

In one embodiment, a method includes accessing a first event profile of an event-management system associated with a first event and one or more second event profiles of the event-management system associated with one or more second events, respectively. The method also includes determining a first event-vector based on the first event profile and one or more second event-vectors based on the one or more second event profiles, respectively. The method further includes calculating one or more similarity scores for the first event profile with respect to each of the one or more second event profiles, respectively, based on a comparison of the first event-vector with each of the second event-vectors. The method also includes transmitting references to one or more of the second event profiles to a user of the event-management system based on the calculated similarity scores for each second event profile.

### TECHNICAL FIELD

The present disclosure generally relates to online event-management systems, and in particular identifying and categorizing events on such systems.

### BACKGROUND

Many websites allow users to conduct a variety of actions online, such as view content, write reviews, order items, purchase tickets, etc. These websites often present the user with a plurality of actions to choose from and allow the user to select the type of action he would like to perform. Once the action is selected, the website typically redirects the client system of the user to a webpage where the action can be completed. For example, some websites allow users to organize events using an online event-management system. An online event-management system may allow an event organizer to organize and manage various aspects of an event, such as, for example, managing attendee registrations and selling tickets, promoting the event, and managing attendee check-in at the event. An online event-management system may also allow users to view event listings, register for events, and purchase tickets for events. Online systems, such as online event-management systems, can typically be accessed using suitable browser clients (e.g., Firefox, Chrome, Internet Explorer).

One problem for online event-management systems is the categorization of events. Owners of event-management systems may wish to categorize events in order to facilitate, for example, business analysis, search functionality, or customer satisfaction. Online event-management systems may process tens of thousands of events, and it can be prohibitively expensive and time consuming to manually categorize each event. Moreover, existing systems that present related events to a user may be inaccurate or may provide events that do not match the search criteria supplied by the user.

### BRIEF DESCRIPTION OF THE DRAWINGS

FIG. 1 illustrates an example system for implementing an online event-management system.

FIG. 2 illustrates an example webpage for creating an event listing.

FIG. 3 illustrates an example logical operation for determining an event-vector based on an event profile and an attribute-vector.

FIG. 4 illustrates an example comparison between two event-vectors to determine a similarity score.

FIG. 5 illustrates two example event-vectors and example techniques for comparing the two event-vectors.

FIG. 6 illustrates an example method for determining related events based on similarity scores.

FIG. 7 illustrates an example computer system.

### DESCRIPTION OF EXAMPLE EMBODIMENTS

### System Overview

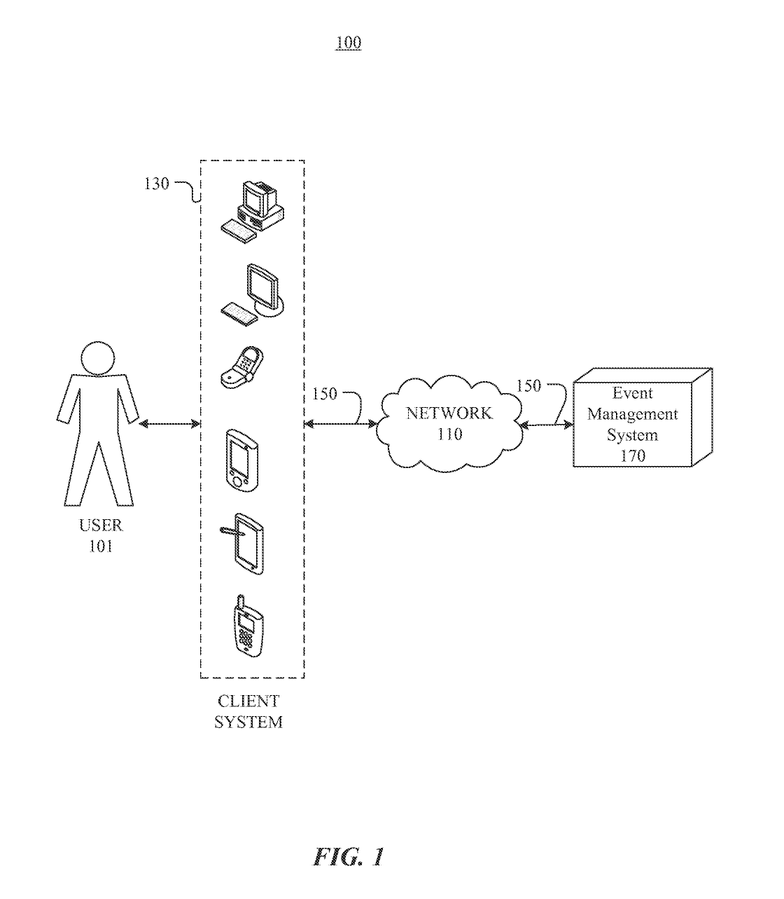

FIG. 1 illustrates an example system 100 for implementing an online event-management system. System 100 includes a user 101, a client system 130, and an event-management system 170 connected to each other by a network 110. Although FIG. 1 illustrates a particular arrangement of user 101, client system 130, event-management system 170, and network 110, this disclosure contemplates any suitable arrangement of user 101, client system 130, event-management system 170, and network 110. As an example and not by way of limitation, two or more of client system 130 and event-management system 170 may be connected to each other directly, bypassing network 110. As another example and not by way of limitation, two or more of client system 130 and event-management system 170 may be physically or logically co-located with each other in whole or in part. Moreover, although FIG. 1 illustrates a particular number of users 101, client systems 130, event-management systems 170, and networks 110, this disclosure contemplates any suitable number of users 101, client systems 130, event-management systems 170, and networks 110. As an example and not by way of limitation, system 100 may include multiple users 101, client systems 130, event-management systems 170, and networks 110.

In particular embodiments, an event-management system 170 may be a network-addressable computing system that can host one or more event organization and management systems. An event-management system 170 may generate, store, receive, or transmit event-related data, such as, for example, event listings, event information details, event history details, event registration details, event organizer details, event attendee details, ticket purchase details, attendee check-in details, or event displays. An event-management system 170 may be accessed by the other components of system 100, either directly or via network 110. In particular embodiments, one or more users 101 may use one or more client systems 130 to access, send data to, and receive data from an event-management system 170. A client system 130 may access an event-management system 170 directly, via network 110, or via a third-party system. A client system 130 may be any suitable computing device, such as, for example, a personal computer, a laptop, a cellular phone, a smartphone, a personal digital assistant, an ultra-mobile PC, or a computing tablet.

Network 110 may be any suitable communications network. As an example and not by way of limitation, one or more portions of network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, another suitable network, or a combination of two or more of these. Network 110 may include one or more networks 110.

Connections 150 may connect client system 130 and event-management system 170 to communication network 110 or to each other. This disclosure contemplates any suitable connections 150. In particular embodiments, one or more connections 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)) or optical (such as for example Synchronous Optical Network (SONET) or Synchronous Digital Hierarchy (SDH)) connections. In particular embodiments, one or more connections 150 each include an ad hoc network, an intranet, an extranet, a VPN, a LAN, a WLAN, a WAN, a WWAN, a MAN, a portion of the Internet, a portion of the PSTN, a cellular telephone network, another suitable connection 150, or a combination of two or more such connections 150. Connections 150 need not necessarily be the same throughout system 100. One or more first connections 150 may differ in one or more respects from one or more second connections 150.

### Event-Management Systems

In particular embodiments, an event-management system 170 may allow users to create, organize and manage events. An event may be, for example, a party, a concert, a conference, a sporting event, a fundraiser, a networking event, or a live performance. Events may occur online (such as, for example, a web-based seminar) and offline (such as, for example, a live seminar in a lecture hall). An online event-management system may allow an event organizer to organize and manage various aspects of an event, such as, for example, creating event profiles, managing attendee registrations and selling tickets, managing funds from ticket sales, promoting the event, and managing attendee check-in at the event. An online event-management system may also allow event attendees to view and manage various aspects of registering for an event, such as, for example, viewing event profiles, viewing event history information, registering for events, and purchasing tickets for events. As an example and not by way of limitation, a first user may use event-management system 170 to create and organize an event. The first user may create an event profile for the event and input event information or event parameters associated with the event. As used herein, the terms “event information” and “event parameter” may be used interchangeably to refer to data in an event profile describing one or more aspects of or related to an event. The event profile may be viewable in one or more webpages or other content served by event-management system 170. One or more second users may then use event-management system 170 to register for the event. The second users may view an event profile associated with the event and then register or purchase tickets for the event. Although this disclosure describes particular types of events, this disclosure contemplates any suitable types of events. Moreover, although this disclosure describes organizing and managing particular aspects of an event, this disclosure contemplates organizing and managing any suitable aspects of an event. Furthermore, although this disclosure uses the term “ticket,” this disclosure is applicable to events that do not use physical tickets and even ticketless events where attendees merely register for the event. Thus, unless context suggests otherwise, the term “ticket” (whether alone or when used in conjunction with other terms) may be considered synonymous with “registration.”

In particular embodiments, an event-management system 170 may have an event profile associated with each event managed by the system. An event profile may be accessed and displayed by any suitable client system 130. An event profile of an event-management system 170 may be associated with an event and may include event information describing the event, the event title, the event identifier, the event date/time, the event category or type, the event details, the description of the event, the event cost or ticket price for the event, the event organizer, the event promoter, the geographic location of the event, the venue for the event, a venue capacity, the performer for the event, the number of tickets available for the event, the type/class of tickets available for the event, the ticket identifiers, the event attendees, the attendee check-in status of each event attendee, the ticket-selling window (a start time and an end time during which tickets can be sold), purchase information for the event, an attendee list for the event, references to additional information (such as, for example, hypertext links to resources related to or describing the event, and the like), privacy settings for the event profile, or other suitable event information. As used herein, the terms “event profile” and “event listing” may be used interchangeably. Although this disclosure describes particular types of event information, this disclosure contemplates any suitable types of event information.

In particular embodiments, the event profile may include an event attendee list. The event attendee list may include, for example, information describing the attendees registered to attend the event, include the attendee's name, phone number, mailing address, email address, IP address, device identifier, purchase information, ticket order information, ticket information, check-in status, and other suitable attendee information. Each attendee may be assigned one or more tickets, and each ticket may have a unique ticket identifier. A ticket identifier may be an identification number, a barcode, a 2D barcode, a QR (quick response) code, or another suitable unique identifier. Although this disclosure describes particular types of information associated with an event attendee list, this disclosure contemplates any suitable types of information associated with an event attendee list.

In particular embodiments, the event profile may include a total number and type of tickets that are available for the event. The type of tickets available for an event may include, for example, premium tickets, general admission tickets, reserved seating tickets, another suitable type of tickets, or two or more such types of tickets. There may be various numbers of each ticket type available for the event. The number of tickets available for an event may be based on a variety of factors. As an example and not by way of limitation, the event organizer or venue owner may specify a particular number of tickets that may be sold for the event. As another example and not by way of limitations, the number of tickets that may be sold may be based on the size or capacity of the venue. Although this disclosure describes particular numbers and types of tickets that are available for an event, this disclosure contemplates any suitable numbers and types of tickets that are available for an event.

In particular embodiments, the event profile may include purchase information for the event. A purchase information may include, for example, a user 101's name, phone number, mailing address, email address, billing address, payment information, ticket order information, credit card information, bank account number, PAYPAL username, cash payment information, money transfer information, address verification system score for the payment, validity information for the payment, or other suitable purchase information. Although this disclosure describes particular types of purchase information, this disclosure contemplates any suitable types of purchase information.

In particular embodiments, each user 101 of event-management system 170 may have an event history information associated with the user 101. Event history information may include event information and purchase information associated with one or more events a user 101 has attended or has registered to attend, as well as purchase history information associated with each event. Event history information may also include event information associated with one or more event profiles a user 101 has created, organized, and managed. Although this disclosure describes particular event history information, this disclosure contemplates any suitable event history information.

In particular embodiments, the event-management system 170 may use a unique client identifier (ID) to identify a user 101. As an example and not by way of limitation, the event-management system 170 may assign a unique device ID to each client system 130. The event-management system 170 may assign each client system 130 with an unique client identifier based on the IP address of the client system 130, tracking cookies on the client system 130 (which may be appended to HTTP requests transmitted by the client system 130), the serial number or asset tag of the client system 130, or other suitable identifying information. As another example and not by way of limitation, the event-management system 170 may assign a unique user ID to each user 101, which the user may provide to the event-management system 170 via a client system 130. The event-management system 170 may assign each user 101 with a username and password that the user 101 can input into client system 130, which then transmits the username and password to the event-management system 170. In particular embodiments, the event-management system 170 can use the unique client identifier (such as, for example, a device ID or user ID) to determine that the user 101 is accessing the system. As yet another example and not by way of limitation, the event-management system 170 may assign a unique client identifier to each attendee of an event. Although this disclosure describes particular types of unique client identifiers, this disclosure contemplates any suitable types of unique client identifiers. Moreover, although this disclosure describes using client identifiers in a particular manner, this disclosure contemplates using client identifiers in any suitable manner.

In particular embodiments, the event-management system 170 may maintain an event-management account for a user 101. The event-management account may contain a variety of information about the user 101. As an example and not by way of limitation, an event-management account may contain personal information (such as, for example, name, sex, location, interests), social network information (such as, for example, friend connections, personal information about user 101's friends), financial information (such as, for example, income, credit history), event history information (such as, for example, the type, data, cost, venue, performers, geographic location of the events a user 101 has organized, registered for, or attended), or other suitable information related to the user 101. Although this disclosure describes event-management accounts containing particular types of information about a user 101, this disclosure contemplates event-management accounts containing any suitable information about a user 101.

In particular embodiments, an event-management system 170 may use a “shopping cart” model to facilitate event registration. As an example and not by way of limitation, event-management system 170 may present a user 101 with a plurality of event profiles. The user 101 may select one or more of the events to register for. When the user 101 selects an event profile on event-management system 170, the event-management system 170 may metaphorically add that item (e.g., registration for the event) to a shopping cart. If appropriate, the user 101 may also select a ticket type or a number of tickets for the event. When the user 101 is done selecting event profiles, then all the items in the shopping cart may be “checked out” (i.e., ordered) when the user 101 provides purchase information (and possibly shipment information). In some embodiments, when a user 101 selects an event profile, then that event profile may be “checked out” by automatically prompting the user for purchase information, such as, for example, the user's name and purchase information. The user 101 then may be presented with a registration webpage that prompts the user for the user-specific registration information to complete the registration. That webpage may be pre-filled with information that was provided by the user 101 when registering for another event or when establishing an event-management account on the event-management system 170. The information may then be validated by the event-management system 170, and the registration may be completed. At this point, the user 101 may be presented with a registration confirmation webpage or a receipt that displays the details of the event and registration details. Event-management system 170 may also charge or withdraw funds from a financial account associated with user 101 based on the purchase information provided by the user 101. The “shopping cart” model may be facilitated by a client system 130 operating offline from event-management system 170. Although this disclosure describes particular means for registering for events and purchasing tickets, this disclosure contemplates any suitable means for registering for events and purchasing tickets.

### Creating Event Listings

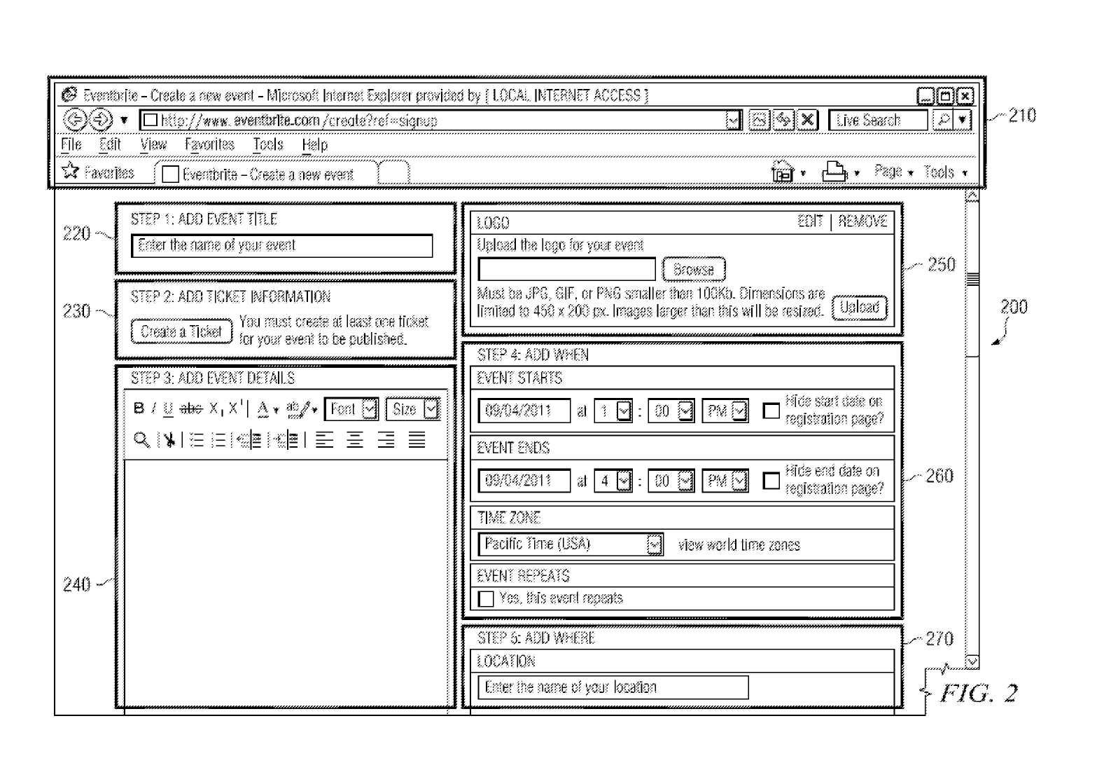

FIG. 2 illustrates an example webpage 200 for creating an event listing on an event-management system 170. In particular embodiments, event-management system 170 may host a webpage that a user 101 may use to input event information, event organizer information, attendee information, or other suitable information in order to create an event listing. The webpage 200 illustrated in FIG. 2 may be automatically generated and presented to a user 101 in response to the user 101 visiting or accessing a website hosted by an event-management system 170. The webpage 200 may be accessed by a client system 130 with a suitable browser client 210. This example webpage contains fields 220, 230, 240, 250, 260, and 270 for an event organizer to input event information to be associated with the event listing. Although this disclosure describes creating an event listing in a particular manner, this disclosure contemplates creating an event listing in any suitable manner. Moreover, although this disclosure describes creating an event listing using particular components, this disclosure contemplates creating an event listing using any suitable components.

In particular embodiments, an event organizer may input particular event information into the fields contained on webpage 200. As an example and not by way of limitation, an event organizer may input an event title in field 220, ticket information for the event in field 230, a detailed description of the event or particular details associated with the event in field 240, an image or logo to be associated with the event listing in field 250, a date or time for the event in field 260, or a location for the event in field 270. Although this disclosure describes creating an event listing with particular event information, this disclosure contemplates creating an event listing with any suitable event information. As an example and not by way of limitation, additional event information may include quantity of tickets, quantity of tickets remaining, event categories, previous events at the same venue, previous events put on by the event organizer, additional images or logos, links to vendor websites, or other suitable event information. Moreover, although this disclosure describes creating an event listing using particular components, this disclosure contemplates creating an event listing using any suitable components.

In particular embodiments, event-management system 170 may generate and assign an event identifier (ID) to an event listing. In particular embodiments, each event listing of event-management system 170 may include a unique event ID that identifies an event listing. As an example and not by way of limitation, event-management system 170 may assign a unique event ID to each event listing, and event-management system 170 may use an event ID to identify or track an event listing. An event ID may be a code assigned to an event listing in response to a user creating an event listing on an event-management system 170. An event ID may be a number, a string of characters, an alphanumeric sequence, or any suitable sequence of numbers, characters, or symbols that may be associated with or used to identify an event listing for an event. In particular embodiments, event-management system 170 may refer to an event listing by referring to its associated event ID. As an example and not by way of limitation, event-management system 170 may store an event list that includes references to a particular event listing and a number of other event listings related to the particular event. In particular embodiments, the event list may include the event ID for the particular event listing and event IDs for the other related event listings. Although this disclosure describes particular types of event identifiers, this disclosure contemplates any suitable types of event identifiers.

### Categorizing Events

In particular embodiments, an event-management system 170 may evaluate an event listing to a category for the event associated with the event listing. The event-management system 170 may access event listings for events and associated event information or payment information and analyze the event listings to determine one or more categories for the events. In particular embodiments, a category of an event may refer to a class, type, feature, or description of an event. Existing systems that allow the event organizer to select the event category may be inaccurate or not match the categories that the event-management system owners would associate with the event. Furthermore, existing automatic event categorization systems that operate via a simple textual analysis may improperly categorize events by giving certain terms improper weight. Although this disclosure describes particular methods for categorizing event listings, this disclosure contemplates any suitable methods for categorizing event listings. Moreover, although this disclosure describes using particular components to categorize event listings, this disclosure contemplates using any suitable components to categorize event listings.

In particular embodiments, an event-management system 170 may identify attributes associated with particular event listings. The attributes may be derived from an analysis of one or more previous event listings. An attribute is a feature or property that characterizes the event information associated with an event listing. In particular embodiments, an attribute may be related to or derived from one or more of: a title of an event; a description of an event; a category of an event; a keyword of an event; a phrase associated with an event; an attendee of an event; an organizer of an event; a venue of an event; a venue capacity for an event; a number of tickets available for an event; a performer of an event; a ticket type of an event; a ticket price for an event; a date or time of an event; a geographic location of an event; or any other suitable event information. As an example and not by way of limitation, attributes may be words, phrases, domains, compounds, rules, user-identified categories, user identifications, usernames, metadata, a combination of two or more such attributes, or other suitable attributes. For example, a word attribute may be the word “pizza,” a phrase attribute may be “learn to cook,” a domain attribute may be a link to “www.makepizza.com,” a compound attribute may be a boolean combination of “word=pizza & username=PizzaChef14,” a user-identified category may be “cooking classes,” or a metadata attribute may be user “PizzaChef14's” previous event listings and website interactions. In particular embodiments, an event information for an event may contain information relating to the location of the event that may be identified as a location attribute. As an example and not by way of limitation, the event title, detailed description of the event, image or logo associated with the event listing, date or time of the event, or location of the event from the event information may provide information relating to the location of the event. In particular embodiments, an attribute may be the event history of an event organizer, including the events they have created and attended. As an example and not by way of limitation, if an event organizer has previously created several “music” events, an attribute may be a rule that events created by the event organizer will have a higher probability of being designated as “music.” In particular embodiments, an attribute may be the event preference and attendances of the event organizers' online friends. In particular embodiments, a set of attributes may be generated by analyzing previous event listings and manually selecting portions of event informations to correspond to attributes. As an example and not by way of limitation, a user 101 may access an event listing where the title is “Dungeons & Dragons Winter Convention.” The user 101 may then manually identify “Dungeons & Dragons,” “Winter,” and “Convention” as three separate attributes. The set of attributes may be also be generated automatically, such as, for example, by using a frequency algorithm such as term-frequency-inverse-document-frequency (tf-idf), or another suitable analytical technique. In particular embodiments, an event-management system 170 may update the set of attributes at particular times. The set of attributes may be updated in real-time or post-facto. As an example and not by way of limitation, an event-management system 170 may update a set of attributes each time an event listing is created by an event organizer. As another example and not by way of limitation, an event-management system 170 may update the set of attributes when the event organizer makes an update or change to the event information associated with an event listing. As yet another example and not by way of limitation, event-management system 170 may update a set of attributes periodically, such as every ten minutes, every hour, every day, or at another suitable period. In particular embodiments, attributes may be given context. As an example and not by way of limitation, context may include information describing the types of events or categories that particular attributes are typically associated with, or determining the meaning of an ambiguous word from surrounding attributes. As an example and not by way of limitation, the word “startup” may be a word attribute that has a high probability of corresponding to entrepreneurial business when other attributes such as the phrases “investment opportunity” or “market niche” are present in the event information. Although this disclosure describes identifying attributes and generating sets of attributes in a particular manner, this disclosure contemplates any suitable methods for identifying attributes and generating sets of attributes. Moreover, although this disclosure describes using particular components to generate sets of attributes, this disclosure contemplates using any suitable components to generate sets of attributes.

In particular embodiments, an event-management system 170 may identify attributes based at least in part on term-frequency-inverse-document-frequency (tf-idf) of one or more words (or terms) in the event information associated with the event listing. The tf-idf is a statistical measure used to evaluate how important a word is to a document in a collection or corpus. The importance increases proportionally to the number of times a word appears in a particular document, but is offset by the frequency of the word in the corpus of documents. The term count in a document is simply the number of times a given term appears in the document. This count may be normalized to prevent a bias towards longer documents (which may have a higher term count regardless of the actual importance of that term in the document) and to give a measure of the importance of the term t within the particular document d. Thus we have the term frequency tf (t,d), defined in the simplest case as the occurrence count of a term in a document. The inverse-document frequency (idf) is a measure of the general importance of the term which is obtained by dividing the total number of documents by the number of documents containing the term, and then taking the logarithm of that quotient. A high weight in tf-idf is reached by a high term frequency in the given document and a low document frequency of the term in the whole collection of documents; the weights hence tend to filter out common terms.

In particular embodiments, event-management system 170 may generate a set of attributes based at least in part on term-frequency-inverse-document-frequency (tf-idf). The following is an example algorithm that an event-management system 170 could use to calculate a tf-idf value for a particular event information:

$${( tf - idf )}_{i , j} = {tf}_{i , j} x {idf}_{i}$$

$$where \text{:}$$

$${tf}_{i , j} = \frac{{n}_{i , j}}{{\sum }_{k} {n}_{k , j}} , and {idf}_{i} = log \frac{\vert D \vert}{\vert \{ d : {t}_{i} ∈ d \} \vert}$$

and where:

(tf-idf)_{i,j} is the term-frequency-inverse-document-frequency,

tf_{i,j} is the term frequency of term i in document j,

idfᵢ is the inverse document frequency of term i,

n_{i,j} is the number of times term i appears in document j,

k is the total number of terms,

D is the total number of documents, and

d is the current document.

Although this disclosure describes generating a set of attributes using a particular algorithm, this disclosure contemplates generating a set of attributes using any suitable algorithm. Moreover, although this disclosure describes generating a set of attributes using particular variables that represent particular information, this disclosure contemplates generating a set of attributes using any suitable variables representing any suitable information.

In particular embodiments, an event-management system 170 may apply an event categorization model to categorize an event listing. An event categorization model may calculate the probability that event information associated with an event listing corresponds to a given event category. An event categorization model may compare a set of attributes from an event listing with a set of attributes typically associated with a particular category to determine the probability that the event listing is associated with that category. As an example and not by way of limitation, one or more event categorization models may calculate that based on a given set of attributes in an event listing, the event listing has a 22% probability of being associated with the “food” category and a 74% probability of being associated with the “conference” category. Although this disclosure describes categorizing event listings in a particular manner, this disclosure contemplates categorizing event listings in any suitable manner.

In particular embodiments, an event-management system 170 may generate an event categorization model using supervised learning to generate a mathematical model or function from control data. A model is a means for describing a system or object. As an example and not by way of limitation, a model may be a data set, function, algorithm, differential equation, chart, table, decision tree, simulation, another suitable model, or two or more such models. A model may describe a variety of systems or objects. A mathematical model may be created for each desired category to represent a set of control event listings, and this model may later be used to classify an event listing. In particular embodiments, the set of control event listings may consist of existing event data and manually selected categories. As an example and not by way of limitation, an event-management system 170 may access a set of control event listings that have been manually categorized as “food” events. The event-management system 170 may then analyze the attributes of these event listings to determine what attributes are associated with food event listings (such as, for example, words like “food,” “eat,” “drink,” or “cook”). A model may then be created based on the identified attributes in the set of control event listings. This model may then be used to categorize other event listings that are not yet associated with a particular category (e.g., newly created event listings) to determine the probability that these other event listings are food events. In particular embodiments, the set of control event listings may be analyzed using logistic regression, binary classification, multiclass classification, or maximum likelihood estimation to refine the categorization model. In particular embodiments, the accuracy of the categorization model may be verified. As an example and not by way of limitation, the validity of a categorization model may be estimated by cross validation to prevent overfitting. In particular embodiments, the validity of a categorization model may be periodically evaluated to ensure that event listings are automatically categorized correctly. As an example and not by way of limitation, event listings may be randomly selected and manually verified to ensure that a categorization model is properly categorizing event listings. Although this disclosure describes generating a categorization model in a particular manner, this disclosure contemplates generating a categorization model in any suitable manner.

In particular embodiments, an event-management system 170 may use one or more event categorization models to automatically categorize events or event listings. The following is an example algorithm that an event-management system 170 could use to automatically categorize an event or event listing:

$${f}_{c} ( z ) = \frac{1}{1 + {e}^{- z}}$$

where:
f_{c}(z) is the probability of an event listing being associated with a category c given a particular set of attributes associated with the event listing; and
z=β₀+β₁x₁+β₂x₂+ . . . +βₖxₖ, where z is the result of a comparison between a set of attributes associated with the event listing and the weights associated with those attributes;

and where:
β is a factor associated with a particular attribute, where β for each attribute may be calculated using the above described supervised learning algorithms such as logistic regression for a set of control event listings; and
x is a measure of an attribute value for a given event listing, where the attribute value may be an indication of the association of, lack of association of, or frequency of an attribute in the event listing.
   In particular embodiments, each factor β may be calculated using logistic regression on a set of control event listings, where both x and f_{c}(z) are known for the control event listings. Following the determination of the factors β for a particular category c, f_{c}(z) may be calculated for event listings where only x is known. In particular embodiments, x may be referred to as an attribute-measure, and x may indicate, for example, the strength of association of an attribute with an event listing, the lack of association of an attribute with an event listing, or the frequency that the attribute appears in the event listing. Although this disclosure describes automatically categorizing events using a particular algorithm, this disclosure contemplates automatically categorizing events using any suitable algorithm. Moreover, although this disclosure describes a categorization model using particular variables that represent particular event information, this disclosure contemplates a categorization model using any suitable variables representing any suitable event information.

In particular embodiments, an event-management system 170 may access event information associated with an event listing to facilitate categorization of the event or event listing. As an example and not by way of limitation, each time an event-management system 170 receives a new event listing, the event-management system 170 may access the event information associated with the event listing in order to determine a category to associate with the event listing. In particular embodiments, the event-management system 170 may store the event information associated with an event listing for later automatic categorization, or it may automatically categorize the new event synchronously with receiving the event listing. Although this disclosure contemplates accessing event information associated with an event listing in a particular manner, this disclosure contemplates accessing event information associated with an event listing in any suitable manner.

In particular embodiments, an event-management system 170 may access a list (or set) comprising a plurality of attributes. In particular embodiments, a list (or set) comprising a plurality of attributes may be referred to as an attribute-vector. The list of attributes may include attributes previously determined by analyzing other event listings. As an example and not by way of limitation, the list of attributes may comprise a list of attributes found in some or all previous event listings. In particular embodiments, an event-management system 170 may access a list of attributes remotely or the list of attributes may be stored locally on the event-management system 170. Although this disclosure describes accessing a list comprising a plurality of attributes in a particular manner, this disclosure contemplates accessing a list of attributes in any suitable manner.

In particular embodiments, an event-management system 170 may compare a list comprising a plurality of attributes to the event information associated with an event listing. As an example and not by way of limitation, the event-management system 170 may compare the event information with the list of attributes to determine the value of each attribute in an event listing based on the event information, such as, for example, what attributes and how many of each attribute from the list are present in the event information. If an attribute is not present in an event listing, a value of zero may be calculated for that attribute. In particular embodiments, the event-management system 170 may create a record of the attributes associated with the event listing. As an example and not by way of limitation, event-management system 170 may generate a vector, a matrix, a sparse matrix, or other suitable data structure indicating the value of each attribute in the attribute list that is associated with the event listing. As another example and not by way of limitation, a comparison may report that an event information contains particular values of the attributes “music,” “guitar lessons,” and a picture of a man playing a guitar. The comparison may also indicate as an attribute whether the event organizer has previously created events for “piano lessons” and “voice lessons.” The event-management system 170 may then determine that certain values of these attributes are associated with a high probability that the event listing is in the “music” category. Although this disclosure describes comparing a list comprising a plurality of attributes with event information associated with an event listing in a particular manner, this disclosure contemplates comparing a list comprising a plurality of attributes with event information associated with an event in any suitable manner.

In particular embodiments, an event-management system 170 may calculate one or more category probabilities for an event listing using one or more categorization models. Each categorization model may calculate a category probability based at least in part on the event information associated with the event listing. As an example and not by way of limitation, each categorization model may include one or more variables based on a preset list of one of more attributes, the presence or frequency of one or more attributes being associated with the event listing, the absence of one or more attributes being associated with the event listing, or other suitable inputs. In particular embodiments, each categorization model may calculate a probability corresponding to a particular category, and the category probability may correspond to the probability that an event listing falls within the category. As an example and not by way of limitation, one categorization model may calculate the probability that an event listing is a “food” event, while another categorization model may calculate the probability that an event is a “conference” event. The event-management system 170 may calculate a category probability for an event listing using a plurality of categorization models in sequence or in parallel. In particular embodiments, the category probability for the event listing may be a percentile rank equal to the percentage of event listings that have a category probability the same or lower than the event listing. As an example and not by way of limitation, an event listing may be classified as having a 23% probability of being a “food” event, as having a 55% probability of being a “conference” event and as having a 94% probability of being an “art” event. In particular embodiments, the event-management system may calculate the probability of an event listing being associated with a category c using the algorithm

$${f}_{c} ( z ) = \frac{1}{1 + {e}^{- z}} .$$

Certain attributes from an attribute list may be given more or less weight by the categorization model when calculating a particular event category more than other categories, and event listings that are associated with these attributes may thus have a higher probability of being associated with that event category. As an example and not by way of limitation, a categorization model that calculates the probability of an event listing being a “food” event may assign high β value to the attribute “cooking class” but a categorization model that calculates the probability of an event listing being a “music” event may assign a low β value to the attribute “cooking class.” Thus, the product of β and x for the attribute “cooking class” would be high for c=“food” but lower (or possibly zero) for c=“music.” As another example and not by way of limitation, a categorization model that calculates the probability that an event listing is associated with a “food” category may give a high weight to attributes such as “pizza,” “cooking,” “tasting,” a location at a restaurant, or a picture of pie, but may give a low or no weight to attributes such as “music,” “transmission fluid,” “Demogorgon,” a picture of a video game console, or a location in a cinema. As another example and not by way of limitation, a categorization model may assign more weight to particular types of attributes, such as, for example, by assigning a high weight to attributes associated with user-identified categories, but assigning a lower weight to attributes associated with images. In particular embodiments, the event-management system 170 may, for each category probability greater than or equal to a threshold probability, associate with the event listing the category corresponding to the category probability. As an example and not by way of limitation, the event-management system 170 may only associate a category with an event listing if that event listing has a category probability over 65%. In particular embodiments, the threshold probability may be different for different categories. As an example and not by way of limitation, a “food” category may require a 65% probability to be associated with an event, while a “business” category may only require a 50% probability to be associated with an event. In particular embodiments, event-management system 170 may store a category associated with an event listing as data in a data store, for example, by modifying the event listing data or by creating a new data file that is associated with the event listing. In particular embodiments, the event-management system 170 may display one or more of the categories associated with the event listing to a user 101. Although this disclosure describes calculating one or more category probabilities for an event listing using one or more categorization models in a particular manner, this disclosure contemplates calculating one or more category probabilities for an event listing using one or more categorization models in any suitable manner. Moreover, although this disclosure describes particular attributes or categories as inputs and results to a categorization model, this disclosure contemplates any suitable inputs and results to a categorization model.

### Determining Related Events

In particular embodiments, event-management system 170 may identify events that are related or may determine how related two events are based on a similarity score. In particular embodiments, event-management system 170 may determine a similarity score for a pair of events, and a similarity score may indicate how related the two events are. A first event may be given one or more similarity scores with respect to one or more second events. A similarity score of a first event with respect to a second event may represent a weight, value, rating, importance, or significance of the similarity of the first and second events. In particular embodiments, a first event may be referred to as having a similarity score with respect to a second event, or equivalently, a first and second event may have a similarity score, or there may be a similarity score between a first and second event. Events that are more similar or have a higher degree of relatedness (i.e., with a higher similarity score) are more likely to be related or have attributes in common. A higher similarity score may represent a stronger or greater degree of similarity or relatedness between the events. As an example and not by way of limitation, a similarity score may be scored on a scale of 0 to 1.0, wherein a score of 0 represents no similarity and a score of 1.0 represents a maximum similarity. As another example and not by way of limitation, a similarity score may be scored on a percentage scale of 0% to 100%, wherein a score of 0% represents no similarity and a score of 100% represents a maximum similarity. Although this disclosure describes using a particular scale for determining similarity scores, this disclosure contemplates using any suitable scale for determining similarity scores.

In particular embodiments, the event-management system 170 may determine a similarity score between a first and second event based at least in part on event-location information for the two events. The event-management system 170 may give higher similarity scores to events that occur at the same venue, location, geographic location, or place. The event-management system 170 may give higher similarity scores to events that occur near one another, such as, for example, within the same neighborhood, the same city, the same region, or within a particular distance of one another (e.g., within 1 mile, 10 miles, 50 miles, or within any suitable distance of one another). As an example and not by way of limitation, if a first event is a concert at Golden Gate Park and a second event is an art exhibit at Golden Gate Park, the event-management system 170 may increase the similarity score between the two events by a particular amount (e.g., by +0.1) based on the events occurring at the same venue/location. Although this disclosure describes determining similarity scores based on particular event-location information, this disclosure contemplates determining similarity scores based on any suitable event-location information.

In particular embodiments, the event-management system 170 may determine a similarity score between a first and second event based at least in part on word attributes of the first and second event profiles. As an example and not by way of limitation, if a first event and a second event both include the word attribute “Dungeons & Dragons” in their event profiles, the event-management system 170 may increase their similarity score by +0.2 based on the shared attribute. As another example and not by way of limitation, if a first and second event profile both include one or more food-related word attributes, such as, for example, “food,” “eat,” “cook,” or “drink,” event-management system 170 may increase their similarity score by from +0.1 to +0.2 based on the number of shared food-related word attributes. Although this disclosure describes determining similarity scores based on particular word-attribute information in a particular manner, this disclosure contemplates determining similarity scores based any suitable word-attribute information in any suitable manner.

In particular embodiments, the event-management system 170 may determine a similarity score for a first event with respect to a second event based on the number of categories associated with each event that match. In particular embodiments, an event profile may be associated with one or more event categories. As an example and not by way of limitation, a particular event may be a food event, an alcohol/wine/beer event, an adult event, a children's event, a music event, a fine arts/crafts events, a visual arts events, a performing arts event, a sporting event, an endurance event, a technology event, an academic event, a networking event, a conference, a social event, a business event, a fundraising event, another suitable type of event, or any combination thereof. Event categories and event categorization are discussed more in U.S. patent application Ser. No. 13/278,902, filed 21 Oct. 2011, which is incorporated herein by reference. In particular embodiments, an event may be associated with one or more preferred event categories. These event categories are the types of events that a user 101 has attended, is interested in, or likes to attend, and may be referred to as a user 101's “taste vector.” A user 101 may indicate that certain types of events are preferred (e.g., by manually providing preferred event types to event-management system 170). Additionally, the event-management system 170 may determine the event categories that should be associated with the user 101 based on the user 101's tastes, event history information, social networking information, other suitable information, or any combination thereof. The event-management system 170 may determine the event categories to be associated with a particular user 101 in an analogous manner to how event categories are determined automatically for event profiles, as described in U.S. patent application Ser. No. 13/278,902, which is incorporated by reference.

In particular embodiments, the event-management system 170 may give higher similarity scores to events that have more categories in common. As an example and not by way of limitation, if a first event and a second event are both food events, the event-management system 170 may increase their similarity score by a particular amount (e.g., +0.1). As another example and not by way of limitation, if the first event and the second event are both food events and music events, the event-management system 170 may increase their similarity score by +0.2. As yet another example and not by way of limitation, if a first event is associated with the categories fundraisers, conferences, and tech events, and a second event is associated with the categories fundraisers, conferences, and music events, the event-management system 170 may increase their similarity score by +0.25. The event-management system 170 may give higher similarity scores to events that match particular types of event categories. As an example and not by way of limitation, if the first and second events are both networking events, their similarity score may increase by +0.1, but if the first and second events are both sporting events, their similarity score may increase by +0.2. Although this disclosure describes determining similarity scores based on particular event categories in a particular manner, this disclosure contemplates determining similarity scores based any suitable event categories in any suitable manner.

In particular embodiments, the event-management system 170 may determine a similarity score between a first and second event based at least in part on their similarity scores with respect to one or more other events. Two events that each have a relatively high similarity score with respect to a third event may be more likely to have a relatively high similarity score with respect to one another. As an example and not by way of limitation, if a first event and a second event each have high similarity scores with a third event, the event-management system 170 may increase the similarity score between first and second events based on their high similarity scores with the third event. Conversely, if a first event has a relatively high similarity score with a third event while a second event has a relatively low similarity score with the third event, the event-management system 170 may decrease the similarity score between the first and second events by a particular amount based on their different similarity scores with the third event. Although this disclosure describes determining similarity scores for two events based on particular similarity scores with respect to particular events, this disclosure contemplates determining similarity scores for two events based on any suitable similarity scores with respect to any suitable events.

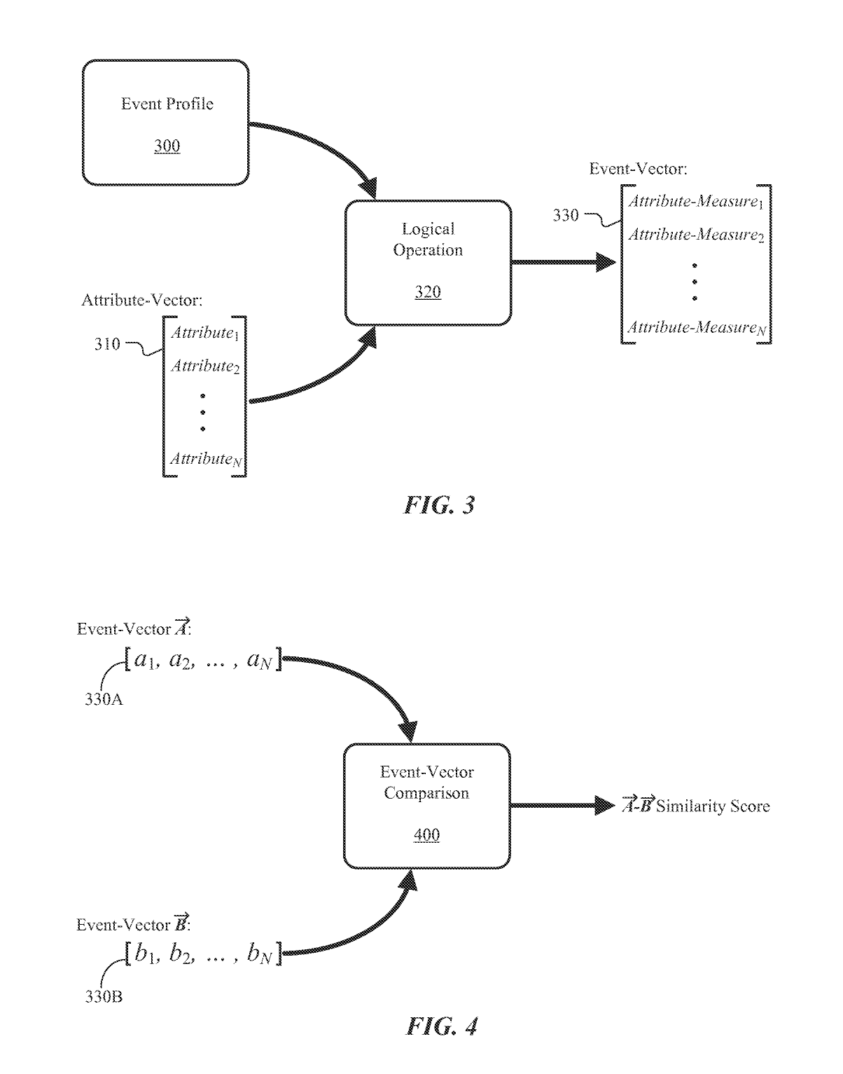

FIG. 3 illustrates an example logical operation 320 for determining event-vector 330 based on event profile 300 and attribute-vector 310. In particular embodiments, an event-management system 170 may calculate a similarity score between a pair of event profiles using particular logical operations, algorithms, or models. The logical operations, algorithms, and models may be based on a variety of factors, such as, for example, the number or type of attributes the events have in common. In particular embodiments, event-management system 170 may determine a similarity score for two events based on event-vectors 330 associated with the two events. In particular embodiments, event profiles 300 may be stored remotely or locally on the event-management system 170, and event-management system 170 may access event profiles 300 from remote or local storage. Each event profile 300 of event-management system 170 may be associated with an event, and, as described above, event profile 300 may include information or parameters that describe or are related to the event. Each event profile 300 may also include a unique event ID that may be used to track or identify event profile 300. As described above, an attribute may be a feature or property related to event profiles 300 of event-management system 170. In particular embodiments, attribute-vector 310 may include a list or a set comprising N attributes, where N is the number of attributes in attribute-vector 310. As an example and not by way of limitation, attribute-vector 310 may have N=6 attributes and may be defined as [music, food, conference, sport, class, volunteer]. In particular embodiments, attribute-vector 310 may include N=10, 100, 1,000, or any suitable number of attributes. In particular embodiments, attribute-vector 310 may be stored remotely or locally on the event-management system 170, and event-management system 170 may access attribute-vector 310 from remote or local storage.

In particular embodiments, event-management system 170 may determine attributes that make up attribute-vector 310 based on an analysis of a group of event profiles 300. As an example and not by way of limitation, event-management system 170 may determine attributes for attribute-vector 310 by analyzing a group of 1,000, 10,000, 100,000, or any suitable number of event profiles, where the group of analyzed event profiles may include events of various types and categories. In particular embodiments, such an analysis of a group of event profiles may be based at least in part on applying a tf-idf analysis to the group of event profiles. In particular embodiments, attributes for attribute-vector 310 may include terms with a relatively high tf-idf values. In particular embodiments, attributes for attribute-vector 310 may include terms that have a high relevance to one or more particular event types or categories. As an example and not by way of limitation, analysis of a group of food-related events may result in words like “food,” “eat,” “drink,” or “cook” being included as attributes in attribute-vector 310. Analysis of other types of events may result in other words (e.g., “sport,” “race,” “dance,” “music,” “class,” “training,” “performance,” “network,” “concert,” “conference,” “volunteer,” “fundraiser,” or any other suitable words) being included as additional attributes in attribute-vector 310. Although this disclosure describes particular attribute-vectors that include particular attributes determined in a particular manner, this disclosure contemplates any suitable attribute-vectors that include any suitable attributes determined in any suitable manner.

In particular embodiments, event-management system 170 may determine an event-vector 330 for an event based on attribute-vector 310 and event profile 300 for the event. In particular embodiments, event-vector 330 may include N attribute-measures so that event-vector 330 and attribute-vector 310 have the same number of elements. In particular embodiments, event-vector 330 may be referred to as a vector in N-dimensional attribute space. In particular embodiments, there is a one-to-one correspondence between attributes and attribute-measures, where each attribute-measure of event-vector 330 is associated with a particular attribute of attribute-vector 310. In particular embodiments, an attribute-measure may indicate the relatedness or strength of association of its corresponding attribute with an event profile 300. In particular embodiments, an attribute-measure may be a number between the limits of 0 and 1.0, where an attribute-measure of 0 represents no association and an attribute-measure of 1.0 represents a maximum strength of association. As an example and not by way of limitation, for attribute-vector 310 defined as [music, food, conference, sport, class, volunteer], an event-vector for a sporting event may have an associated event-vector of [0.1, 0.1, 0, 1, 0, 0], indicating the sporting event has a strong association with attribute “sport,” some association with attributes “music” and “food,” and no association with attributes “conference,” “class,” or “volunteer.” As another example and not by way of limitation, an event-vector for a conference event involving food may have an event-vector of [0, 0.8, 1, 0, 0.2, 0.1], indicating the conference event has a strong association with attributes “food” and “conference,” some association with attributes “class” and “volunteer,” and no association with attributes “music” or “sport.” In particular embodiments, an attribute-measure may be represented on a percentage scale between 0% and 100%, or an attribute-measure may be any suitable number between any suitable limits. Although this disclosure describes particular event-vectors that include particular attribute-measures having particular values between particular limits, this disclosure contemplates any suitable event-vectors that include any suitable attribute-measures having any suitable values between any suitable limits.

As illustrated in FIG. 3, attribute-measures of event-vector 330 may be determined by performing logical operation 320 between event profile 300 and attribute-vector 310. In particular embodiments, logical operation 320 may refer to any suitable algorithm, model, function, or calculation for determining event-vector 330 based on event profile 300 and attribute-vector 310. In particular embodiments, logical operation 320 may be an algorithm based at least in part on applying a tf-idf analysis to one or more attributes of attribute-vector 310 with respect to event profile 300. In particular embodiments, event-management system 170 may calculate a tf-idf value for each attribute of attribute-vector 310 with respect to event profile 300, and a value may be assigned to each associated attribute-measure of event-vector 330 based on each calculated tf-idf value. As an example and not by way of limitation, a tf-idf analysis of attribute “food” may be applied to event profile 300 which represents a conference event involving food, and based on the calculated tf-idf value, a value of 0.9 may be assigned to the attribute-measure of event-vector 330 corresponding to attribute “food.” In particular embodiments, calculated tf-idf values may be scaled by a scaling factor, and the scaled tf-idf value may be assigned to an attribute-measure. As an example and not by way of limitation, calculated tf-idf values may be scaled or normalized so that they map to a particular range, such as, for example, from 0 to 1.0. Although this disclosure describes determining attribute-measures for an event-vector using a particular logical operation, this disclosure contemplates determining attribute-measures using any suitable logical operation.

FIG. 4 illustrates an example comparison 400 between two event-vectors to determine a similarity score. In particular embodiments, event-management system 170 may calculate a similarity score for a first event profile with respect to a second event profile based on comparison 400 of the first event-vector with the second event-vector. In the example of FIG. 4, event-vectors \vec{A} 330A and \vec{B} 330B each include N attribute-measures, a₁ through a_{N} and b₁ through b_{N}, respectively, and each event-vector corresponds to a particular event profile 300. In particular embodiments, N, the number of attribute-measures in an event-vector may be 10, 100, 1,000, or any suitable number of attribute-measures. Event-vector \vec{A} 330A can be written as \vec{A}=[a₁, a₂, . . . , a_{N}], and event-vector \vec{B} 330B can be written as \vec{B}=[b₁, b₂, . . . , b_{N}]. In particular embodiments, attribute-vector 310 and event-vector 330 may each be represented or illustrated as a row vector or a column vector. In particular embodiments, event-management system 170 may perform a comparison 400 of event-vectors \vec{A} 330A and \vec{B} 330B to determine a similarity score between event profiles associated with event-vectors \vec{A} 330A and \vec{B} 330B.

In particular embodiments, comparison 400 of event-vector \vec{A} 330A with event-vector \vec{B} 330B may include calculating a Euclidean distance between event-vectors \vec{A} 330A and \vec{B} 330B. The Euclidean distance between event-vectors \vec{A} 330A and \vec{B} 330B may be defined as the distance between the ends of the vectors, or |\vec{A}−\vec{B}|, where \vec{A}−\vec{B} is the vector formed by subtracting B from A, and |\vec{A}−\vec{B}| is the magnitude of Â−\vec{B}. The vector Â−\hat{B} can be expressed as:

Â−\hat{B}=[(a₁−b₁),(a₂−b₂), . . . ,(a_{N}−b_{N})],

and the Euclidean distance between \vec{A} and \vec{B}, |\vec{A}−\vec{B}|, can be found from:

|\vec{A}−\vec{B}|=\sqrt{(a₁−b₁)²+(a₂−b₂)²+ . . . +(a_{N}−b_{N})²}.

In particular embodiments, two event-vectors with a relatively small Euclidean distance between them may have a relatively high similarity score (e.g., close to 1) and a relatively strong similarity between their corresponding event profiles. Conversely, two event-vectors with a relatively large Euclidean distance between them may have a relatively low similarity score (e.g., close to 0) and a relatively weak similarity between their corresponding event profiles. In particular embodiments, a similarity score based on an exponential function may be expressed as

Similarity Score=e^{-k|\vec{A}-\vec{B}|}^{^{P}},

where k is an exponent scaling factor greater than 0 and P is an exponent power factor, so that two event-vectors with a small Euclidean distance between them will have a similarity score close to 1, and two event-vectors with a large Euclidean distance will have a similarity score close to 0. As an example and not by way of limitation, for k=1 and P=1, a similarity score may be defined as

Similarity Score=e^{-|\vec{A}-\vec{B}|}.

Although this disclosure describes calculating similarity scores based on particular exponential functions applied to a Euclidean distance calculation, this disclosure contemplates calculating similarity scores based on any suitable exponential functions or other suitable functions applied to a Euclidean distance calculation.

As an example and not by way of limitation, three example event-vectors 330 in a 3-dimensional attribute space may be expressed as \vec{C}=[1,1,0],

$${D}^{->} = [ \frac{1}{2} , \frac{1}{2} , 0 ] ,$$

and \vec{E}=[0,0,1]. The Euclidean distance between \vec{C} and \vec{D} is

$$\sqrt{{( 1 - \frac{1}{2} )}^{2} + {( 1 - \frac{1}{2} )}^{2} + {( 0 - 0 )}^{2}} = \frac{1}{\sqrt{2}} ≅ 0.71 ,$$

and the Euclidean distance between \vec{C} and \vec{E} is \sqrt{(1−0)²+(1−0)²+(0−1)²}=\sqrt{3}≈1.73. For an example similarity score expressed as Similarity Score=e^{-(Euclidean Distance)}, the similarity score between event vectors \vec{C} and \vec{D} is approximately e^{-(0.707)}≈0.49, and the similarity score between event vectors \vec{C} and \vec{E} is approximately e^{-(1.732)}=0.18, indicating a greater degree of similarity between \vec{C} and \vec{D} than between \vec{C} and \vec{E}.

In particular embodiments, comparison 400 of event-vector \vec{A} 330A with event-vector \vec{B} 330B may include calculating a cosine similarity between event-vectors \vec{A} 330A and \vec{B} 330B. In particular embodiments, a cosine similarity between two vectors may be defined as the cosine of the angle between the two vectors in N-dimensional attribute space. The cosine similarity between event-vectors \vec{A} 330A and \vec{B} 330B may be expressed as

$$Cosine Similarity = cos {θ}_{AB} = \frac{{A}^{->} \cdot {B}^{->}}{\vert {A}^{->} \vert \times \vert {B}^{->} \vert} = \frac{{\sum }_{i = 1}^{N} {a}_{i} \times {b}_{i}}{\sqrt{{\sum }_{i = 1}^{N} {( {a}_{i} )}^{2}} \times \sqrt{{\sum }_{i = 1}^{N} {( {b}_{i} )}^{2}}} ,$$

where \vec{A}·\vec{B} is the dot product of event-vectors \vec{A} and \vec{B}. In particular embodiments, the cosine similarity between any two vectors may range from −1 to +1. In particular embodiments, for event-vectors 330 with attribute-measures that are greater than or equal to zero, the cosine similarity between any two event-vectors may range from 0 to +1. In particular embodiments, a similarity score for two event-vectors may be defined as the cosine similarity between the two event-vectors. In particular embodiments, two event-vectors with a cosine similarity (and a similarity score) close to 1 may have a strong similarity between their corresponding event profiles, and two event-vectors with a cosine similarity close to 0 may have a weak similarity between their corresponding event profiles. A cosine similarity of 1 indicates that two vectors have the same angle or direction in attribute space, and a cosine similarity of 0 indicates that two vectors are orthogonal. As an example and not by way of limitation, for the three event vectors, \vec{C}, \vec{D}, and \vec{E} defined above, the cosine similarity between \vec{C} and \vec{D} is

$$\frac{\frac{1}{2} + \frac{1}{2}}{\sqrt{2} \times \sqrt{\frac{1}{2}}} = 1 ,$$

indicating a maximum degree of similarity between \vec{C} and \vec{D}. The cosine similarity between \vec{C} and \vec{E} is

$$\frac{0}{\sqrt{2} \times \sqrt{1}} = 0 ,$$

indicating a minimum degree of similarity between \vec{C} and \vec{E}. Although this disclosure describes calculating similarity scores based on a particular cosine similarity function applied to particular event-vectors, this disclosure contemplates calculating similarity scores based on any suitable angular function applied to any suitable event-vectors.

In particular embodiments, comparison 400 of event-vector \vec{A} 330A with event-vector \vec{B} 330B may include calculating a Pearson correlation or any other suitable calculation with event-vectors \vec{A} 330A and \vec{B} 330B. Although this disclosure describes calculating similarity scores by performing particular comparisons between event-vectors, this disclosure contemplates calculating similarity scores by performing any suitable comparisons between event-vectors. Moreover, although this disclosure describes calculating a similarity score for a pair of event profiles using a particular logical operation, this disclosure contemplates calculating a similarity score for a pair of event profiles using any suitable logical operation.

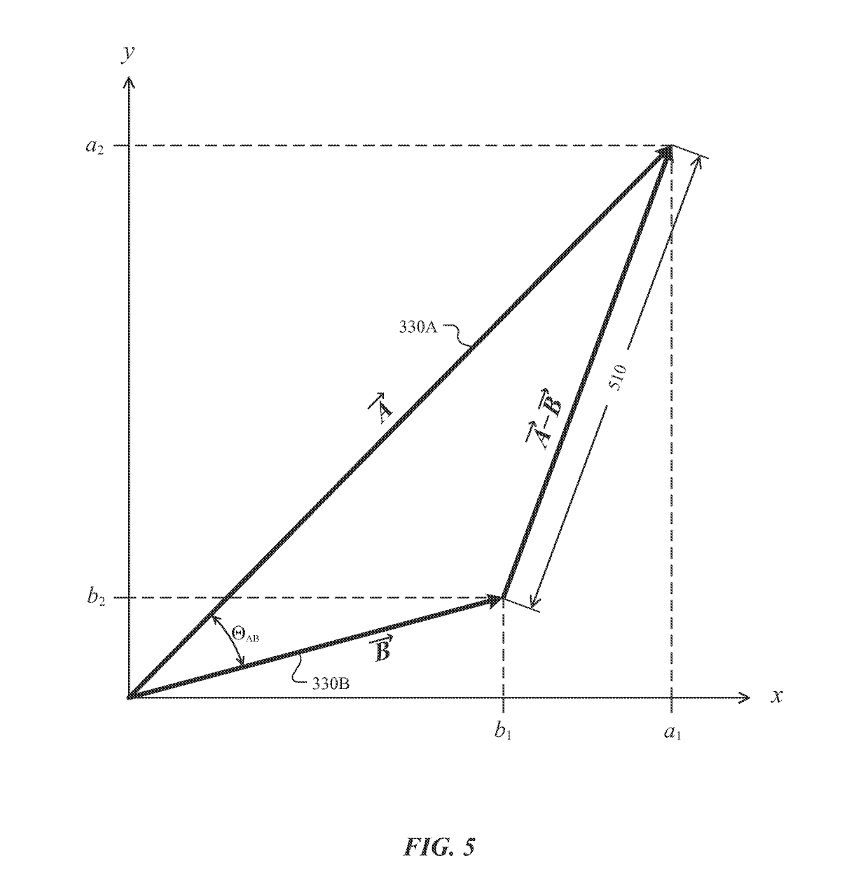

FIG. 5 illustrates two example event-vectors \vec{A} 330A and \vec{B} 330B and example techniques for comparing the two event-vectors. In FIG. 5, example event-vectors \vec{A} 330A and \vec{B} 330B are plotted in a 2-dimensional attribute space, and event-vectors \vec{A} 330A and \vec{B} 330B each include two attribute-measures, a₁, a₂ and b₁, b₂, respectively. Event-vector \vec{A} 330A can be written as \vec{A}=[a₁, a₂], and event-vector \vec{B} 330B can be written as \vec{B}=[b₁, b₂]. For a comparison between event-vectors that includes calculating a Euclidean distance, the Euclidean distance between \vec{A} and \vec{B} can be expressed as |\vec{A}−\vec{B}|=\sqrt{(a₁−b₁)²+(a₂−b₂)²}. For a comparison between event-vectors that includes calculating a cosine similarity, the cosine similarity between \vec{A} and \vec{B} can be expressed as

$$Cosine Similarity = cos {θ}_{AB} = \frac{{a}_{1} {b}_{1} + {a}_{2} {b}_{2}}{\sqrt{{a}_{1}^{2} + {a}_{2}^{2}} \times \sqrt{{b}_{1}^{2} + {b}_{2}^{2}}} .$$

In particular embodiments, event-vectors \vec{A} 330A and \vec{B} 330B may each include 10, 100, 1,000, or any suitable number of attribute-measures, and event-vector comparison 400 may include partitioning each event-vector into two or more sub-vectors. In particular embodiments, event-vector comparison 400 may include calculating a distance between each of the corresponding sub-vectors of event-vectors \vec{A} 330A and \vec{B} 330B, where a distance may refer to a Euclidean distance, a cosine similarity, a Pearson correlation, or any other suitable measure of distance between two vectors. In particular embodiments, calculating a similarity score may include calculating a weighted sum of distances between each of the corresponding sub-vectors of event-vectors \vec{A} 330A and \vec{B} 330B. In particular embodiments, event-vectors \vec{A} 330A and \vec{B} 330B may each be partitioned into q sub-vectors, where q is an integer greater than or equal to 2. A distance measure DM may be calculated for each pair of corresponding sub-vectors, and then a similarity score for event-vectors \vec{A} 330A and \vec{B} 330B may be calculated as a weighted sum of the sub-vector distance measures. As an example and not by way of limitation, a similarity score between event-vectors \vec{A} 330A and \vec{B} 330B may be expressed as Similarity Score=Σⱼ₌₁^{q}wⱼ×DMⱼ, where wⱼ is a weighting factor and DMⱼ is a distance measure for sub-vectors \vec{A}ⱼ and \vec{B}ⱼ.

As an example and not by way of limitation, event-vector \vec{A} 330A, written as \vec{A}=[a₁, a₂, . . . , a_{N}], may be partitioned into three (q=3) sub-vectors written as \vec{A}₁=[a₁, . . . , a_{L-1}], \vec{A}₂=[a_{L}, . . . , a_{M-1}], and \vec{A}₃=[a_{M}, . . . , a_{N}], where L, M, and N are integers, and L<M<N. Similarly, event-vector \vec{B} 330B may be partitioned into three sub-vectors written as \vec{B}₁=[b₁, . . . , b_{L-1}], \vec{B}₂=[b_{L}, . . . , b_{M-1}], and \vec{B}₃=[b_{M}, . . . , b_{N}]. In particular embodiments, event-vector comparison 400 may calculate a distance DMⱼ between each of the three sub-vector pairs. In particular embodiments, each distance DMⱼ may be based on any suitable distance calculation. As an example and not by way of limitation, DM₁ may be based on a Euclidean distance, DM₂ may be based on a cosine similarity, and DM₃ may be based on a Pearson correlation. In particular embodiments, each sub-vector may be associated with a particular set of attributes or characteristics of an event profile. As an example and not by way of limitation, sub-vectors \vec{A}₁ and \vec{B}₁ may be associated with word attributes, sub-vectors \vec{A}₂ and \vec{B}₂ may be associated with event-location attributes, and sub-vectors \vec{A}₃ and \vec{B}₃ may be associated with event-price attributes. A similarity score for event-vectors \vec{A} 330A and \vec{B} 330B may be based on the weighted sum w₁DM₁+w₂DM₂+w₃DM₃. In particular embodiments, weighting factors w may all be set to 1 so that each sub-vector distance is weighted equally. In particular embodiments, weighting factors w may be given different values to apply more weight or importance to particular sub-vector distances. As an example and not by way of limitation, weighting factors may be assigned values w₁=1, w₂=0.5, and w₃=0.5 so that word attributes are given a higher importance than event-location or event-price attributes. Although this disclosure describes calculating similarity scores by performing particular comparisons between particular sub-vectors of event-vectors, this disclosure contemplates calculating similarity scores by performing any suitable comparisons between any suitable sub-vectors of event-vectors.

In particular embodiments, an event-management system 170 may determine similarity scores for a first event profile with respect to each of a group of one or more second event profiles, respectively, based on a comparison of the first event-vector with each of the second event-vectors. In particular embodiments, the group of second event profiles may include approximately 10,000 event profiles, 100,000 event profiles, or any suitable number of event profiles. In particular embodiments, the first event and the one or more second events may be prior or pending events. A prior event may be an event that has already taken place and may be referred to as an expired event or a past event. A pending event may be an event that has not yet taken place and may be referred to as a live event or a future event. As an example and not by way of limitation, an event-management system 170 may calculate similarity scores for a prior event with respect to one or more pending events. As another example and not by way of limitation, an event-management system 170 may calculate similarity scores for a prior event with respect to one or more prior events. As yet another example and not by way of limitation, an event-management system 170 may calculate similarity scores for a pending event with respect to one or more pending events. As yet another example and not by way of limitation, an event-management system 170 may calculate similarity scores for a pending event with respect to one or more prior events. Although this disclosure describes determining similarity scores between particular prior events, pending events, and prior and pending events, this disclosure contemplates determining similarity scores between any suitable prior events, pending events, and prior and pending events.

In particular embodiments, an event-management system 170 may determine similarity scores for each event profile of a group of one or more first event profiles with respect to a group of one or more second event profiles. The group of first event profiles may represent prior or pending events, and the group of second event profiles may represent prior or pending events. In particular embodiments, the groups of first and second event profiles may each include approximately 10,000 event profiles, 100,000 event profiles, 200,000 event profiles, or any suitable number of event profiles. F may represent the number of first event profiles, and S may represent the number of second event profiles. In particular embodiments, an event-management system 170 may calculate similarity scores for F first event profiles with respect to S second event profiles, corresponding to a total of F×S similarity scores. In particular embodiments, event-management system 170 may store 16 bytes of data for each calculated similarity score (e.g., 8 bytes for a similarity score plus 8 bytes for an associated event ID), corresponding to a total data size of F×S×16 bytes. As an example and not by way of limitation, the group of first event profiles may include approximately F=150,000 prior event profiles, and the group of second event profiles may include approximately S=150,000 pending event profiles. In this example, an event-management system 170 may compute a total of (150,000)²=22.5×10⁹ similarity scores, and the set of all similarity scores and event IDs corresponds to a total data size of 150,000×150,000×16 bytes, or approximately 335 gigabytes. As discussed below, the data comprising similarity scores and event IDs may be referred to as an event list. In particular embodiments, the event-management system 170 may store the top T similarity scores and event IDs from the group of second event profiles, where T is 10, 50, 100, or any suitable number. In this case, the total data size may be expressed as F×T×16 bytes. As an example and not by way of limitation, for F=150,000 first event profiles and T=100 top similarity scores, the total data size is 150,000×100×16 bytes, or approximately 230 megabytes. Although this disclosure describes particular sets of similarity scores and event IDs having particular data sizes, this disclosure contemplates any suitable sets of similarity scores and event IDs having any suitable data sizes.

In particular embodiments, an event-management system 170 may determine similarity scores for a plurality of first event profiles with respect to a plurality of second event profiles. Event-management system 170 may calculate a similarity score for each first event profile with respect to each of the second event profiles. Each event may have an event ID associated with it, and event-management system 170 may store the event identifier associated with each first event profile along with event IDs and similarity scores for each second event profile. In particular embodiments, event-management system 170 may create or store an event list that includes event IDs. In particular embodiments, an event list may include event IDs and corresponding similarity scores. In particular embodiments, an event list may be referred to as a list, a data store, a data file, or a table. For each first event profile, event-management system 170 may create a row or a column that includes the event ID for the first event profile, event IDs for each second event profile, and similarity scores for the first event profile with respect to each of the second event profiles. In particular embodiments, the first event profiles may correspond to prior events, and the second event profiles may correspond to pending events. As an example and not by way of limitation, a row of an event list may appear as follows:

### <Prior Event ID> (Pending Event ID 1, Similarity Score) (Pending Event ID 2, Similarity Score) (Pending Event ID 3, Similarity Score) . . . ,

where Prior Event ID is an event ID for one of the prior event profiles, and for each pending event, a pair of values is generated corresponding to a pending event ID and a similarity score for the prior event and the pending event. In particular embodiments, an event-management system 170 may store an event list remotely or locally on the event-management system 170. Although this disclosure describes generating and storing a list of event IDs and similarity scores in a particular format, this disclosure contemplates generating and storing a list of event IDs and similarity scores in any suitable format.

In particular embodiments, an event list may include F rows with each row corresponding to a particular first event, and each row may include S pairs of values with each pair of values corresponding to a particular second event. In particular embodiments, event-management system 170 may sort or rank each of the pairs of second-event values in each row based on their respective similarity score. As an example and not by way of limitation, second event IDs and their respective similarity scores may be ordered from highest similarity score to lowest similarity score. As an example and not by way of limitation, if the event-management system 170 determines events A, B, C, D, and E as having similarity scores of 0.2, 0.5, 1.0, 0.8, and 0.3, respectively, with respect to a first event, the event-management system 170 may generate a row of an event list that appears as follows:

### <First Event ID> (Event C ID, 1.0) (Event D ID, 0.8) (Event B ID, 0.5) (Event E ID, 0.3) (Event A ID, 0.2)

As another example and not by way of limitation, the event-management system 170 may sort events in order of their similarity scores and may not include the similarity scores in an event list. A row of such an event list may appear as follows:

### <First Event ID> (Event C ID) (Event D ID) (Event B ID) (Event E ID) (Event A ID)

Although this disclosure describes sorting or storing events in a particular manner, this disclosure contemplates sorting or storing events in any suitable manner.

In particular embodiments, the event-management system 170 may determine or select a sub-set of second events based on the sorting or ranking of the second events. Events with higher similarity scores may be selected over user events with lower similarity scores. In particular embodiments, only events with a similarity score over a threshold score may be selected. As an example and not by way of limitation, continuing with the example in the prior paragraph, if the event-management system 170 selects only events with a similarity score greater than or equal to 0.8, it may select events C and D. In particular embodiments, the event-management system 170 may select the top T events. As an example and not by way of limitation, if the event-management system selects the top T=3 events, it may select events C, D, and B. In particular embodiments, the event-management system may form an event list from the selected sub-set of events and may discard the remaining events. In particular embodiments, an event list may include F rows with each row corresponding to a particular first event, and each row may include T pairs of values with each pair of values corresponding to the sub-set of second events having the highest similarity scores. As an example and not by way of limitation, for F=100,000 first event profiles, S=200,000 second event profiles, and T=100 top scores, an event list may include 100,000 rows, and each row may include 100 second event IDs having the highest similarity scores. Although this disclosure describes determining or selecting events in a particular manner, this disclosure contemplates determining or selecting events in any suitable manner.

In particular embodiments, an event-management system 170 may periodically perform updates to a set of first and second event profiles or to an event list corresponding to the first and second event profiles. In particular embodiments, the event-management system 170 may perform updates on an hourly, daily, or weekly basis, or on any suitable update schedule. In particular embodiments, updates performed by event-management system 170 may include adding events to or removing events from a set of event profiles or an event list. In particular embodiments, the set of first event profiles may be a set of prior events, and event-management system 170 may periodically remove events that have occurred a particular number of days in the past and add events that have recently become prior events. As an example and not by way of limitation, the event-management system 170 may perform updates on a daily basis, and a set of prior events may include prior events that have occurred less than 14 days in the past. The event-management system 170 may remove from a set of prior events any events that have occurred more than 14 days in the past and may add to the set of prior evens any events that have occurred since a previous update cycle (e.g., within the last 24 hours). As another example and not by way of limitation, each row of the event list may correspond to a particular prior event, and the event-management system 170 may remove from the event list any row corresponding to an event that has occurred more than 14 days in the past and may add rows to the event list corresponding to any events that have recently become prior events.

In particular embodiments, the set of second event profiles may be a set of pending events, and event-management system 170 may perform an update by removing events that are no longer pending (e.g., events that have occurred since the last update) and adding any new pending events (e.g., events that have been created since the last update). As an example and not by way of limitation, if the event-management system 170 performs updates on a daily basis, any event that has occurred since the previous or most recent update cycle (e.g., within the last 24 hours) may be removed from the set of pending events, and any event that has been added to the event-management system 170 since the last update cycle may be added to the set of pending events. As another example and not by way of limitation, each element or entry in each row of the event list may correspond to a pending event, and the event-management system 170 may remove from the event list any pending-event entries that are no longer pending (e.g., events that have occurred since the last update). As yet another example and not by way of limitation, a set of prior events may include 100,000 events, and a set of pending events may include 150,000 events. Since the last update cycle the following changes may have happened within the event-management system 170: 5,000 prior events now have an occurrence date more than a particular number of days in the past (e.g., more than 14 days in the past); 10,000 new pending events have been added; and 8,000 events that were pending are now prior events. After event-management system 170 runs an update, the set of prior events may include 103,000 events (=100,000−5,000+8,000), and the set of pending events may include 152,000 events (=150,000−8,000+10,000).

In particular embodiments, event-management system 170 may perform incremental updates to an event list based on any changes that have occurred since a previous update. In particular embodiments, updates performed by event-management system 170 may include determining similarity scores between any new prior event and each of the pending events, including any recently-added, or new, pending events. In particular embodiments, updates performed by event-management system 170 may include determining similarity scores between any new pending event and each of the prior events. In particular embodiments, updates may also include updating an event list by determining new entries to add to the event list. In particular embodiments, event-management system may add a new row to the event list for each new prior event. In particular embodiments, event-management system may sort entries and add one or more new entries to a row of the event list based on the calculated similarity scores. In particular embodiments, event-management system may remove one or more entries from a row of the event list based on the calculated similarity scores. As an example and not by way of limitation, for the event-list row described above:

### <First Event ID> (Event C ID, 1.0) (Event D ID, 0.8) (Event B ID, 0.5) (Event E ID, 0.3) (Event A ID, 0.2),

if, during an update, a new second event F is found to have a similarity score of 0.4, the event-management system 170 may remove Event A from the row. After an update, the row may appear as:

### <First Event ID> (Event C ID, 1.0) (Event D ID, 0.8) (Event B ID, 0.5) (Event F ID, 0.4) (Event E ID, 0.3),

where event F has been inserted into the row based on its similarity score. Although this disclosure describes particular updates made to a set of event profiles or to an event list, this disclosure contemplates any suitable updates made to a set of event profiles or to an event list.

In particular embodiments, an event-management system 170 may allow a user 101 to search for or view particular event profiles, such as, for example, prior event profiles, pending event profiles, or any suitable event profiles. In particular embodiments, an event-management system 170 may receive a request or query from a user to access a page of the event-management system 170 associated with a particular event profile. In particular embodiments, the event-management system 170 may transmit the page to the user, where the page may include information associated with the requested event profile as well as references to one or more other event profiles. In particular embodiments, the other event profiles may be related to the requested event profile based on the similarity scores between the requested event profile and the other event profiles. In particular embodiments, the transmitted page may be a webpage associated with the event-management system 170. In particular embodiments, the transmitted page may be a user interface of a native application associated with the event-management system 170. In particular embodiments, the references transmitted to the user may include one or more hyperlinks, brief descriptions, thumbnail images, or other suitable references, or any suitable combination of references associated with the one or more other event profiles.

In particular embodiments, in response to a user's search or request for a particular event profile, event-management system 170 may transmit references to one or more related event profiles based on calculated similarity scores between the particular event profile and the one or more other event profiles. In particular embodiments the event profiles whose references are transmitted to the user may correspond to event profiles with the highest similarity scores. In particular embodiments, the highest similarity scores may refer to a percentage of the top similarity scores (e.g., the top 5%, 10%, or any suitable percentage). In particular embodiments, the highest similarity scores may refer to the top 5, 10, 20, or any suitable number of top similarity scores. As an example and not by way of limitation, a user may request a particular prior event, and in response to the user's request and based on an event list of the event-management system 170, the event-management system 170 may transmit 5, 10, 20, or any suitable number of references to one or more related pending events that have the highest similarity scores with respect to the requested prior event. In particular embodiments, an event-management system 170 may recommend particular events to a user based on one or more events that the user has searched for or viewed and based on similarity scores between the respective events. Although this disclosure describes particular event references transmitted to a user in response to particular requests, this disclosure contemplates any suitable event references transmitted to a user in response to any suitable requests.

In particular embodiments, the event-management system 170 may generate one or more advertisements for a user comprising information corresponding to one or more events. Each event may be advertised individually. Alternatively, a particular advertisement may be generated for multiple events. The event-management system 170 may generate any suitable advertisement for a user. As an example and not by way of limitation, the advertisement may be included in a webpage, text, graphic image, email, instant message, text message, audio message, page, MMS text, social network message, another suitable format, or any combination thereof. The advertisement may contain details about the event, a link to the event profile, other suitable information, or any combination thereof. In particular embodiments, an advertisement may be generated based on similarity scores between events a user has viewed or searched for and other events. As an example and not by way of limitation, if a user has requested a particular event from event-management system 170, then an advertisement for one or more other events having relatively high similarity scores with respect to the requested event may be presented to the user. The advertisement for the one or more related events may contain links to the event profiles of the related events. Although this disclosure describes generating particular advertisements in a particular manner, this disclosure contemplates generating any suitable advertisements in any suitable manner.

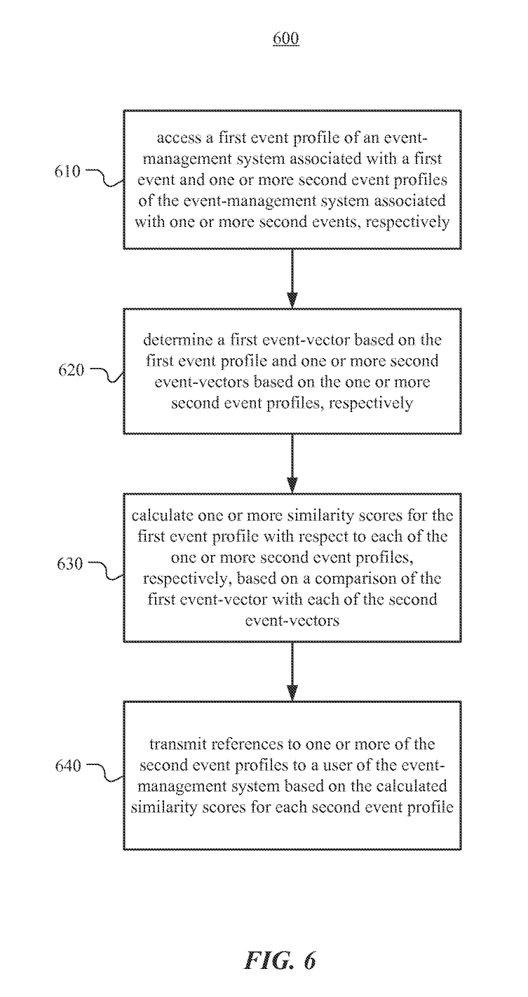

FIG. 6 illustrates an example method 600 for determining related events based on similarity scores. The method may begin at step 610, where event-management system 170 may access a first event profile of an event-management system associated with a first event and one or more second event profiles of the event-management system associated with one or more second events, respectively. The first event may be a prior or pending event, and the second events may be prior or pending events. At step 620, event-management system 170 may determine a first event-vector based on the first event profile and one or more second event-vectors based on the one or more second event profiles, respectively. In particular embodiments, determining an event-vector for a particular event may include accessing an attribute-vector and performing a logical operation, such as, for example, a tf-idf calculation, between the event profile of the event and the attribute-vector. At step 630, event-management system 170 may calculate one or more similarity scores for the first event profile with respect to each of the one or more second event profiles, respectively, based on a comparison of the first event-vector with each of the second event-vectors. In particular embodiments, a comparison of two event-vectors may include calculating a Euclidean distance or a cosine similarity between two event-vectors or between two sub-vectors of two event vectors. At step 640, event-management system 170 may transmit references to one or more of the second event profiles to a user of the event-management system based on the calculated similarity scores for each second event profile. Particular embodiments may repeat one or more steps of the method of FIG. 6, where appropriate. Although this disclosure describes and illustrates particular steps of the method of FIG. 6 as occurring in a particular order, this disclosure contemplates any suitable steps of the method of FIG. 6 occurring in any suitable order. Moreover, although this disclosure describes and illustrates an example method for determining related events based on similarity scores including the particular steps of the method of FIG. 6, this disclosure contemplates any suitable method for determining related events based on similarity scores including any suitable steps, which may include all, some, or none of the steps of the method of FIG. 6, where appropriate. Furthermore, although this disclosure describes and illustrates particular components, devices, or systems carrying out particular steps of the method of FIG. 6, this disclosure contemplates any suitable combination of any suitable components, devices, or systems carrying out any suitable steps of the method of FIG. 6.

### Systems and Methods

In particular embodiments, the methods and processes described herein may be implemented as a series of computer-readable instructions, embodied on a data storage medium, that when executed are operable to cause one or more processors to implement particular operations. For smaller datasets, operations may be executed on a single computing platform or node. For larger systems and resulting data sets, parallel computing platforms may be used. As an example and not by way of limitation, development platforms that can leverage Hadoop or other Map-Reduce execution engines may be used. The Apache Software Foundation has developed a collection of programs called Hadoop, which includes a distributed file system and an application programming interface (API) and corresponding implementation of MapReduce. In particular embodiments, system 100 may comprise a high-availability cluster of commodity servers with one or more slave servers as nodes. Ordinarily, nodes in a high-availability cluster are redundant, so that if one node crashes while performing a particular application, the cluster software can restart the application on one or more other nodes. Multiple nodes may also facilitate parallel processing of large databases. In particular embodiments, a master server may receive a job from a client and then assigns tasks resulting from that job to one or more slave servers or nodes, which do the actual work of executing the assigned tasks upon instruction from the master and which move data between tasks. In particular embodiments, the client jobs will invoke Hadoop's MapReduce functionality. Likewise, in particular embodiments, a master server governs a distributed file system that supports parallel processing of large databases. As an example and not by way of limitation, a master server may manage the file system's namespace and block mapping to nodes, as well as client access to files, which are actually stored on slave servers or nodes. In turn, in particular embodiments, the slave servers do the actual work of executing read and write requests from clients and perform block creation, deletion, and replication upon instruction from the master server. Although this disclosure describes using particular computing platforms, this disclosure contemplates using any suitable computing platforms.

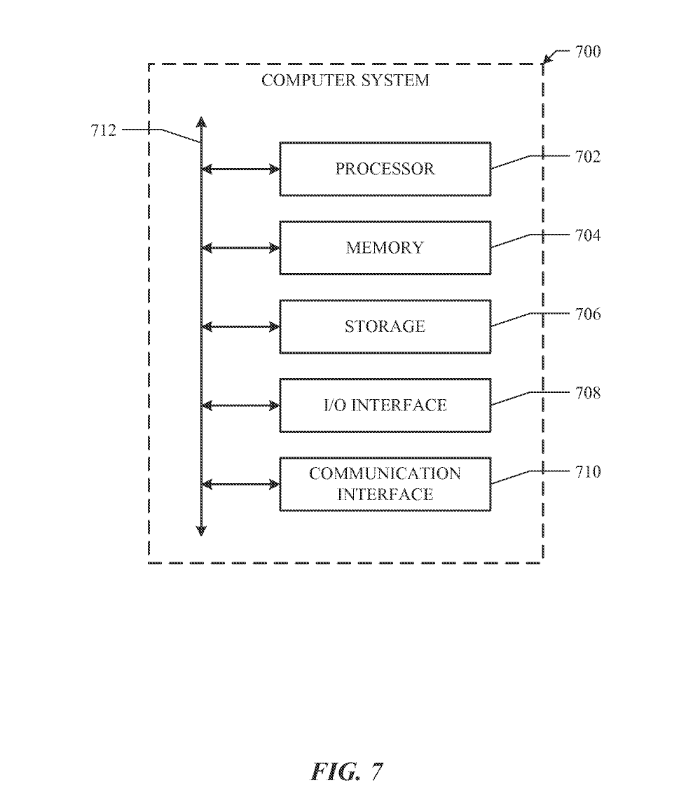

FIG. 7 illustrates an example computer system 700. In particular embodiments, one or more computer systems 700 perform one or more steps of one or more methods described or illustrated herein. In particular embodiments, one or more computer systems 700 provide functionality described or illustrated herein. In particular embodiments, software running on one or more computer systems 700 performs one or more steps of one or more methods described or illustrated herein or provides functionality described or illustrated herein. Particular embodiments include one or more portions of one or more computer systems 700. Herein, reference to a computer system may encompass a computing device, and vice versa, where appropriate. Moreover, reference to a computer system may encompass one or more computer systems, where appropriate.

This disclosure contemplates any suitable number of computer systems 700. This disclosure contemplates computer system 700 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 700 may include one or more computer systems 700; be unitary or distributed; span multiple locations; span multiple machines; span multiple data centers; or reside in a cloud, which may include one or more cloud components in one or more networks. Where appropriate, one or more computer systems 700 may perform without substantial spatial or temporal limitation one or more steps of one or more methods described or illustrated herein. As an example and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In particular embodiments, computer system 700 includes a processor 702, memory 704, storage 706, an input/output (I/O) interface 708, a communication interface 710, and a bus 712. Although this disclosure describes and illustrates a particular computer system having a particular number of particular components in a particular arrangement, this disclosure contemplates any suitable computer system having any suitable number of any suitable components in any suitable arrangement.

In particular embodiments, processor 702 includes hardware for executing instructions, such as those making up a computer program. As an example and not by way of limitation, to execute instructions, processor 702 may retrieve (or fetch) the instructions from an internal register, an internal cache, memory 704, or storage 706; decode and execute them; and then write one or more results to an internal register, an internal cache, memory 704, or storage 706. In particular embodiments, processor 702 may include one or more internal caches for data, instructions, or addresses. This disclosure contemplates processor 702 including any suitable number of any suitable internal caches, where appropriate. As an example and not by way of limitation, processor 702 may include one or more instruction caches, one or more data caches, and one or more translation lookaside buffers (TLBs). Instructions in the instruction caches may be copies of instructions in memory 704 or storage 706, and the instruction caches may speed up retrieval of those instructions by processor 702. Data in the data caches may be copies of data in memory 704 or storage 706 for instructions executing at processor 702 to operate on; the results of previous instructions executed at processor 702 for access by subsequent instructions executing at processor 702 or for writing to memory 704 or storage 706; or other suitable data. The data caches may speed up read or write operations by processor 702. The TLBs may speed up virtual-address translation for processor 702. In particular embodiments, processor 702 may include one or more internal registers for data, instructions, or addresses. This disclosure contemplates processor 702 including any suitable number of any suitable internal registers, where appropriate. Where appropriate, processor 702 may include one or more arithmetic logic units (ALUs); be a multi-core processor; or include one or more processors 702. Although this disclosure describes and illustrates a particular processor, this disclosure contemplates any suitable processor.

In particular embodiments, memory 704 includes main memory for storing instructions for processor 702 to execute or data for processor 702 to operate on. As an example and not by way of limitation, computer system 700 may load instructions from storage 706 or another source (such as, for example, another computer system 700) to memory 704. Processor 702 may then load the instructions from memory 704 to an internal register or internal cache. To execute the instructions, processor 702 may retrieve the instructions from the internal register or internal cache and decode them. During or after execution of the instructions, processor 702 may write one or more results (which may be intermediate or final results) to the internal register or internal cache. Processor 702 may then write one or more of those results to memory 704. In particular embodiments, processor 702 executes only instructions in one or more internal registers or internal caches or in memory 704 (as opposed to storage 706 or elsewhere) and operates only on data in one or more internal registers or internal caches or in memory 704 (as opposed to storage 706 or elsewhere). One or more memory buses (which may each include an address bus and a data bus) may couple processor 702 to memory 704. Bus 712 may include one or more memory buses, as described below. In particular embodiments, one or more memory management units (MMUs) reside between processor 702 and memory 704 and facilitate accesses to memory 704 requested by processor 702. In particular embodiments, memory 704 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 704, where appropriate. Although this disclosure describes and illustrates particular memory, this disclosure contemplates any suitable memory.

In particular embodiments, storage 706 includes mass storage for data or instructions. As an example and not by way of limitation, storage 706 may include a hard disk drive (HDD), a floppy disk drive, flash memory, an optical disc, a magneto-optical disc, magnetic tape, or a Universal Serial Bus (USB) drive or a combination of two or more of these. Storage 706 may include removable or non-removable (or fixed) media, where appropriate. Storage 706 may be internal or external to computer system 700, where appropriate. In particular embodiments, storage 706 is non-volatile, solid-state memory. In particular embodiments, storage 706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 706 taking any suitable physical form. Storage 706 may include one or more storage control units facilitating communication between processor 702 and storage 706, where appropriate. Where appropriate, storage 706 may include one or more storages 706. Although this disclosure describes and illustrates particular storage, this disclosure contemplates any suitable storage.

In particular embodiments, I/O interface 708 includes hardware, software, or both, providing one or more interfaces for communication between computer system 700 and one or more I/O devices. Computer system 700 may include one or more of these I/O devices, where appropriate. One or more of these I/O devices may enable communication between a person and computer system 700. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 708 for them. Where appropriate, I/O interface 708 may include one or more device or software drivers enabling processor 702 to drive one or more of these I/O devices. I/O interface 708 may include one or more I/O interfaces 708, where appropriate. Although this disclosure describes and illustrates a particular I/O interface, this disclosure contemplates any suitable I/O interface.

In particular embodiments, communication interface 710 includes hardware, software, or both providing one or more interfaces for communication (such as, for example, packet-based communication) between computer system 700 and one or more other computer systems 700 or one or more networks. As an example and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 710 for it. As an example and not by way of limitation, computer system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 700 may include any suitable communication interface 710 for any of these networks, where appropriate. Communication interface 710 may include one or more communication interfaces 710, where appropriate. Although this disclosure describes and illustrates a particular communication interface, this disclosure contemplates any suitable communication interface.

In particular embodiments, bus 712 includes hardware, software, or both coupling components of computer system 700 to each other. As an example and not by way of limitation, bus 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

### Miscellaneous

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising, by one or more processors associated with one or more computing devices of an event-management system:
accessing, by one or more of the processors, a first event profile of the event-management system associated with a first event and one or more second event profiles of the event-management system associated with one or more second events, respectively;
determining, by one or more of the processors, a first event-vector based on the first event profile and one or more second event-vectors based on the one or more second event profiles, respectively;
calculating, by one or more of the processors, one or more similarity scores for the first event profile with respect to each of the one or more second event profiles, respectively, based on a comparison of the first event-vector with each of the second event-vectors; and
transmitting, by one or more of the processors, references to one or more of the second event profiles to a user of the event-management system based on the calculated similarity scores for each second event profile.

2. The method of claim 1, further comprising:
receiving a request from the user to access a page of the event-management system associated with the first event profile; and
transmitting the page to the user, the page comprising information associated with the first event profile and the references to the one or more second event profiles.

3. The method of claim 2, wherein the page is a webpage associated with the event-management system.

4. The method of claim 2, wherein the page is a user interface of a native application associated with the event-management system.

5. The method of claim 1, wherein determining the first event-vector based on the first event profile and the one or more second event-vectors based on the one or more second event profiles comprises:
accessing an attribute-vector comprising a plurality of attributes; and
determining an event-vector for an event profile by performing a logical operation between the event profile and the attribute-vector.

6. The method of claim 5:
wherein for each event profile the event-vector for the event profile comprises a plurality of attribute-measures, each attribute-measure of the event-vector being associated with an attribute of the attribute-vector; and
wherein determining the event-vector for the event profile by performing the logical operation between the event profile and the attribute-vector comprises:
calculating a term-frequency-inverse-document-frequency (tf-idf) value for an attribute of the attribute-vector with respect to the event profile; and
assigning a value to an attribute-measure associated with the attribute based on the calculated tf-idf value.

7. The method of claim 1, wherein the first event is a prior event.

8. The method of claim 1, wherein the first event is a pending event.

9. The method of claim 1, wherein one or more of the second events are prior events.

10. The method of claim 1, wherein one or more of the second events are pending events.

11. The method of claim 1, further comprising:
accessing an event identifier associated with the first event profile;
determining a sub-set of the one or more second event profiles, wherein the sub-set corresponds to second event profiles having highest similarity scores of the calculated similarity scores;
accessing event identifiers associated with each event profile of the sub-set of second event profiles; and
storing an event list comprising the event identifier for the first event and the event identifiers for the sub-set of second event profiles.

12. The method of claim 11, wherein the event list further comprises similarity scores associated with the sub-set of second event profiles, and further comprising sorting the event list according to the similarity scores.

13. The method of claim 11, further comprising:
removing from the event list an event identifier associated with a second event that has occurred a particular number of days in the past;
accessing one or more new second event profiles that were recently added to the one or more second event profiles of the event-management system;
determining one or more new second event-vectors based on the one or more new second event profiles, respectively;
calculating one or more new similarity scores for the first event profile with respect to each of the one or more new second event profiles, respectively, based on a comparison of the first event-vector with each of the new second event-vectors;
determining a sub-set of the one or more new second event profiles having highest similarity scores of the calculated similarity scores;
accessing event identifiers associated with each event profile of the sub-set of the one or more new second event profiles; and
adding to the event list the event identifiers associated with the sub-set of the one or more new second event profiles.

14. The method of claim 1, wherein the comparison of the first event-vector with each of the second event-vectors comprises calculating a Euclidean distance between the first event-vector and each of the second event-vectors.

15. The method of claim 1, wherein:
the first event-vector and the one or more second event-vectors each comprise a plurality of sub-vectors;
each sub-vector of the first event-vector corresponds to a sub-vector of each of the second event-vectors; and
the comparison of the first event-vector with each of the second event-vectors comprises calculating a weighted sum of distances between each of the corresponding sub-vectors of the first event-vector and each of the second event-vectors, wherein a calculated distance between a sub-vector of the first event-vector and a sub-vector of the second event-vector is based on a Euclidean distance, a cosine similarity, or a Pearson correlation.

16. The method of claim 1, wherein each similarity score is a percentage that indicates an amount of similarity between the first event profile and a second event profile of the one or more second event profiles.

17. The method of claim 1, wherein the one or more of the second event profiles whose references are transmitted to the user correspond to second event profiles with highest similarity scores of the calculated similarity scores.

18. The method of claim 1, wherein an event profile associated with an event comprises one or more of: a title of the event; a description or details of the event; a category or type of the event; a keyword of the event; a phrase associated with the event; an attendee of the event; an organizer of the event; a promoter of the event; a venue of the event; a venue capacity for the event; a number of tickets available for the event; a performer for the event; a hyperlink to additional information for the event; a type or class of tickets for the event; a ticket-selling window for the event; purchase information for the event; a ticket price for the event; a date or time of the event; a geographic location of the event; or any combination thereof.

19. A system comprising: one or more processors; and a memory coupled to the processors comprising instructions executable by the processors, the processors operable when executing the instructions to:
access a first event profile of an event-management system associated with a first event and one or more second event profiles of the event-management system associated with one or more second events, respectively;
determine a first event-vector based on the first event profile and one or more second event-vectors based on the one or more second event profiles, respectively;
calculate one or more similarity scores for the first event profile with respect to each of the one or more second event profiles, respectively, based on a comparison of the first event-vector with each of the second event-vectors; and
transmit references to one or more of the second event profiles to a user of the event-management system based on the calculated similarity scores for each second event profile.

20. One or more computer-readable non-transitory storage media embodying instructions that are operable when executed to:
access a first event profile of an event-management system associated with a first event and one or more second event profiles of the event-management system associated with one or more second events, respectively;
determine a first event-vector based on the first event profile and one or more second event-vectors based on the one or more second event profiles, respectively;
calculate one or more similarity scores for the first event profile with respect to each of the one or more second event profiles, respectively, based on a comparison of the first event-vector with each of the second event-vectors; and
transmit references to one or more of the second event profiles to a user of the event-management system based on the calculated similarity scores for each second event profile.
